(19) United States
(12) Patent Application Publication
(10) Pub. No.: US 2012/0067225 A1
(43) Pub. Date: Mar. 22, 2012

(54) Toaster-griller for corn-on-the-cob and rolls

(76) Inventors: Yitizhak Attias, Tel Aviv (IL); Ido Gabai, Tel Aviv (IL)

(21) Appl. No.: 12/924,148

(22) Filed: Sep. 22, 2010

(51) Int. Cl. A47J 37/08

(52) U.S. Cl. 99/339

(57) ABSTRACT

A toaster-griller with one or more round openings that is designed so that corn-on-the-cob may be inserted and grilled and so that rolls may be inserted and defrosted, warmed, or toasted.

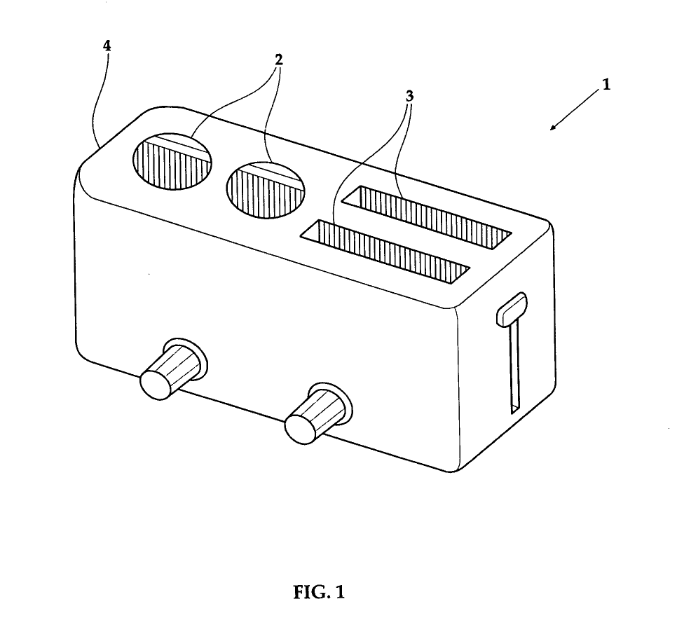

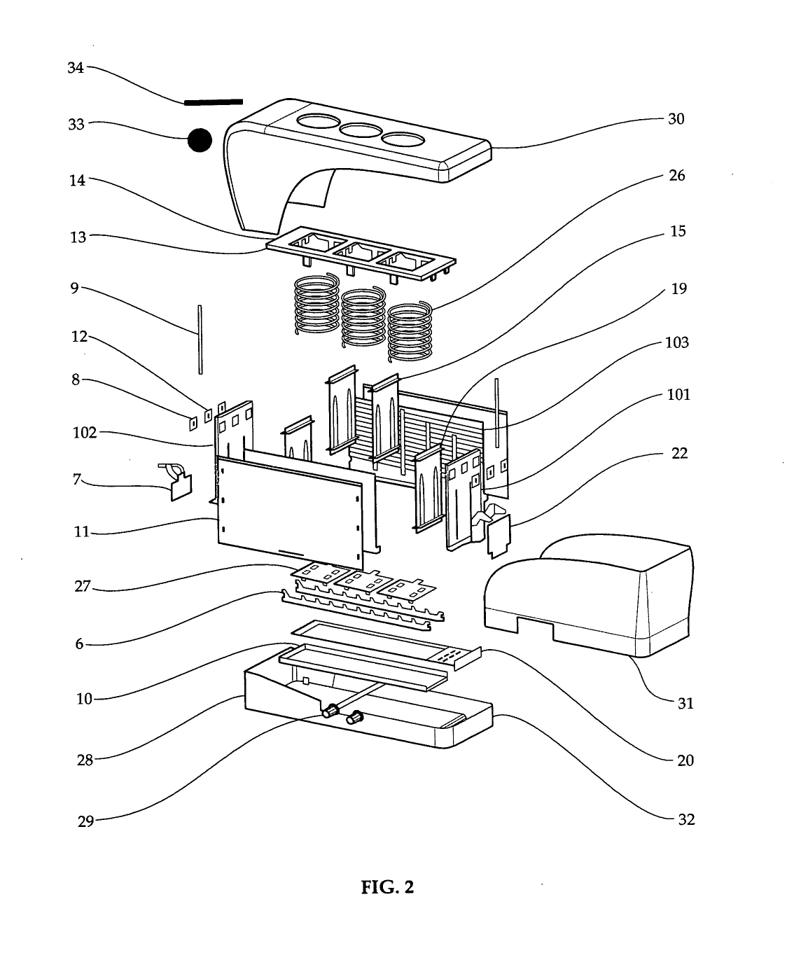

### TECHNICAL FIELD

The present invention refers to a toaster-griller designed for grilling corn-on-the-cob and for toasting rolls.

### BACKGROUND ART

Many people often wish to grill corn-on-the-cob or to defrost, warm, or toast rolls. The present invention offers an efficient response to these needs.

### THE INVENTION

A wide variety of toasters exist today that have narrow, rectangular openings into which slices of bread are inserted in order to defrost, warm, or toast them. The main objective of the present invention is to provide a toaster-griller that has round openings of a suitable diameter that are designed for grilling corn-on-the-cob and for defrosting, warming, and toasting rolls.

The toaster-griller (1), subject of the invention, is designed, constructed, and manufactured like a standard toaster, but for one or more round openings (2) into which the user may insert rolls and/or corn-on-the-cob.

One version of the toaster-griller (1), subject of the invention, has one or more round openings (2) that are intended for rolls and corn-on-the-cob as well as one or more rectangular openings (3) intended for slices of bread. Thus, the toaster-griller (1), subject of the invention, can satisfy a variety of needs including the need to defrost, warm, and toast slices of bread [which are inserted into the rectangular openings (3)] as well as the need to toast rolls or grill corn-on-the-cob [which are inserted into the round openings (2)]. Another version of the toaster-griller (1), subject of the invention, has one or more round openings (2) only.

The toaster-griller (1), subject of the present invention, is constructed according to the same principles as is a standard toaster, and so there is no need to specify in detail its inner structure and all of its components.

Nevertheless, the inventor wishes to emphasize that the inner structure of the toaster-griller (1), subject of the invention, is adapted so that the inner heating elements and all of the other toaster-griller systems are suitable for the round opening (2).

The toaster-griller (1) includes a housing (4); one or more round openings (2); a heating element associated with each opening; and a means for lowering and raising the product into and out of the opening (lift mechanism). The lift mechanism, which is used to lower and raise the relevant products into and out of the openings, can be a mechanism already known in the art.

The heating elements can be of the electrical resistance type, as are known in the art. The toaster-griller (1) can be equipped both with a common controller that activates the heating element and a means for automatically activating the heating element. The lift mechanism should include an automatic release mechanism that holds the lift mechanism in “down” position and releases it after a preset time or when a preset temperature is reached, as is known in the art.

In addition, the housing can include a control panel used to operate the toaster-griller (1).

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawing No. 1 depicts the toaster-griller (1) that comprises a housing (4) with two round openings (2) and two rectangular openings (3).

Drawing No. 2 depicts the toaster-griller (1) in greater detail and shows the followings parts: Front metal plate (101), back metal plate (102), long heating element (103), bridge (6), lift mechanism (7), lift holder (8), lifting pin (9), bottom metal plate (10), long metal body (11), isolator (12), middle metal plate (13), top metal plate (14), two-sided heating element (15), one-sided heating element (19), slider (20), electricity board (22), spring box (26), spring bed (27), plastic bottom (28), handle (29), plastic cover (30), plastic body (31), pulley block (32), heat control switch (33), calibration switch (34).

What is claimed is:

1. A toaster-griller with one or more round openings designed for rolls and/or corn-on-the-cob.
